(19) United States
(12) Patent Application Publication
(10) Pub. No.: US 2020/0037092 A1
(43) Pub. Date: Jan. 30, 2020

(54) SYSTEM AND METHOD OF BINAURAL AUDIO REPRODUCTION

(71) Applicant: National Tsing Hua University, Hsinchu City (TW)

(72) Inventors: Ming-Sian Bai, Hsinchu City (TW); Yi-Wen Chen, Hsinchu City (TW)

(73) Assignee: National Tsing Hua University, Hsinchu City (TW)

(21) Appl. No.: 16/131,054

(22) Filed: Sep. 14, 2018

(30) Foreign Application Priority Data
Jul. 24, 2018 (TW) 107125568

(51) Int. Cl. H04S 7/00; H04R 3/12; G06F 17/16; H04R 5/02; H04R 5/04

(52) U.S. Cl. CPC H04S 7/30; H04R 3/12; H04S 2400/01; H04R 5/02; H04R 5/04; G06F 17/16

(57) ABSTRACT

A binaural audio reproduction system is provided. The binaural audio reproduction system includes a speaker array and a filter matrix. The speaker array includes multiple speakers respectively disposed at multiple predetermined positions. The filter matrix outputs multiple driving signals to control the speakers, so as to produce a predetermined sound response to each of multiple control points within a control space. The driving signals of the filter matrix are determined according to a condition in reaching a match level between the sound response and a target sound response to be obtained at the control points from a virtual speaker array.

### CROSS-REFERENCE TO RELATED APPLICATION

This application claims the priority benefit of Taiwan application serial no. 107125568, filed on Jul. 24, 2018. The entirety of the above-mentioned patent application is hereby incorporated by reference herein and made a part of this specification.

### BACKGROUND

### Technical Field

The disclosure relates to an audio reproduction technology, and more particularly relates to a physical speaker array for realizing system and method of binaural audio reproduction.

### Description of Related Art

A speaker is one of many types of important tools for reproducing an audio environment in another separate environment. As ordinarily known, for example, when multiple speakers in an indoor space produce sound according to the drive of electrical audio signals of respective speakers, under the integrated effect of the speakers, audio environments of stereo sound, channel 5.1 virtual surround sound, etc., are produced.

However, if the speakers are placed at different positions, live sound effects which can be heard are different. For example, it is more difficult to obtain better surround sound effects for a small space as compared to a big space, which allows speakers (including quantity and positioning) to have a broader placement setting.

How to drive a set of physical speakers to produce sound effects of a set of virtual speakers is a topic in need of continued research and development.

### SUMMARY

The disclosure provides by controlling the driving method of a set of physical speakers, a set of virtual speakers producing a target audio response to multiple control points can be simulated.

According to an embodiment, the binaural audio reproduction system of the disclosure includes a speaker array and a filter matrix. The speaker array includes multiple speakers respectively disposed at multiple predetermined positions. The filter matrix outputs multiple driving signals to control the speakers, so as to produce a predetermined sound response to each of the multiple control points within a control space. The driving signals of the filter matrix are determined according to a condition in reaching a match level between the sound response and a target sound response to be obtained at the control points from a virtual speaker array.

According to an embodiment, the binaural audio reproduction method of the disclosure includes the following steps: providing a speaker array comprised of multiple speakers respectively disposed at multiple predetermined positions; determining a virtual speaker array comprised of multiple virtual speakers respectively disposed at multiple predetermined positions; providing a filter matrix for outputting multiple driving signals to control the speakers, so as to produce a predetermined sound response to each of the multiple control points within a control space. The driving signals of the filter matrix are determined according to a condition in reaching a match level between the sound response and a target sound response to be obtained at the control points from the virtual speaker array.

According to an embodiment, regarding the system and the method of binaural audio reproduction, the virtual speaker array includes multiple predetermined virtual sound sources. The target sound response is an ideal response of the virtual sound sources respectively at each of the control points and is a two-dimensional target matrix m set according to a matching model.

According to an embodiment, regarding the system and the method of binaural audio reproduction, the target matrix m is set according to a theoretical calculation.

According to an embodiment, regarding the system and the method of binaural audio reproduction, the target matrix m is set according to measurement values at the control points.

According to an embodiment, regarding the system and the method of binaural audio reproduction, each of the speakers has a two-dimensional G array constructed with reference to a response value to the control points, a one-dimensional h matrix is constructed corresponding to multiple matrix element values of the driving signals outputted by the filter matrix, wherein the arithmetic relationship between the h matrix and the G matrix is:

h=[G^{H}G+β²I]⁻¹G^{H}m,

where G^{H} matrix is a transposed-conjugate matrix of the G matrix, I is a unit matrix, parameter β is an adjustable parameter, “−1” represents inverse matrix, and m represents the target matrix m.

According to an embodiment, regarding the system and the method of binaural audio reproduction, the condition in reaching a match level is that the difference value between the product of the G matrix and the h matrix and the target matrix m lies within a predetermined range.

According to an embodiment, regarding the system and the method of binaural audio reproduction, when a protruding point is produced between the filters of the filter matrix, the protruding point can be eliminated by changing the parameter β, wherein the smaller the value of the parameter β, the smaller the difference value.

According to an embodiment, regarding the system and the method of binaural audio reproduction, the virtual speaker array includes multiple virtual speakers. distinguishing the virtual speakers between left ear virtual speakers and right ear virtual speakers according to a left ear and a right ear of a user based on an earphone mechanism.

To make the aforementioned and other features of the disclosure more comprehensible, several embodiments accompanied with drawings are described in details as below.

### BRIEF DESCRIPTION OF THE DRAWINGS

FIG. 1 is a schematic diagram of a binaural audio reproduction system according to an embodiment of the disclosure.

FIG. 2 is a schematic diagram of a virtual speaker array according to an embodiment of the disclosure.

FIG. 3 is a schematic diagram of a physical speaker array according to an embodiment of the disclosure.

FIG. 4 is a schematic diagram of a matching mechanism of the physical speaker array and the virtual speaker array at control points according to an embodiment of the disclosure.

### DETAILED DESCRIPTION OF DISCLOSED EMBODIMENTS

The disclosure provides using the driving method produced by a filter matrix to a set of physical speakers, a set of virtual speakers producing a target sound response to multiple control points can be simulated.

Multiple embodiments are provided below to illustrate the disclosure, but the disclosure is not limited to the embodiments.

FIG. 1 is a schematic diagram of a binaural audio reproduction system according to an embodiment of the disclosure. Referring to FIG. 1, the binaural audio reproduction system includes a speaker array 114 comprised of multiple physical speakers 112 respectively disposed at multiple predetermined positions. The binaural audio reproduction system further includes a filter matrix 100 for outputting multiple driving signals, S1, S2, . . . , S_{Ls}, to control the physical speakers 112, so as to produce a predetermined sound response to each of the multiple control points C₁, C₂, . . . , C_{LC} within a control space 104.

For the mechanism of the filter matrix 100, driving signals of the filter matrix 100 are determined according to a condition in reaching a match level between the sound response and a target sound response to be obtained at the control points C₁, C₂, . . . , C_{LC} from a virtual speaker array 108. The virtual speaker array 108 includes multiple virtual speakers 110 respectively disposed at predetermined positions. The space where the virtual speaker array 108 is at is a virtual space of sound, for example, a different space from the physical space where the speaker array 114 is at. In an embodiment, for example, the virtual space where the virtual speaker array 108 is at is more spacious than the physical space where the speaker array 114 is at, such that better surround effects can be obtained.

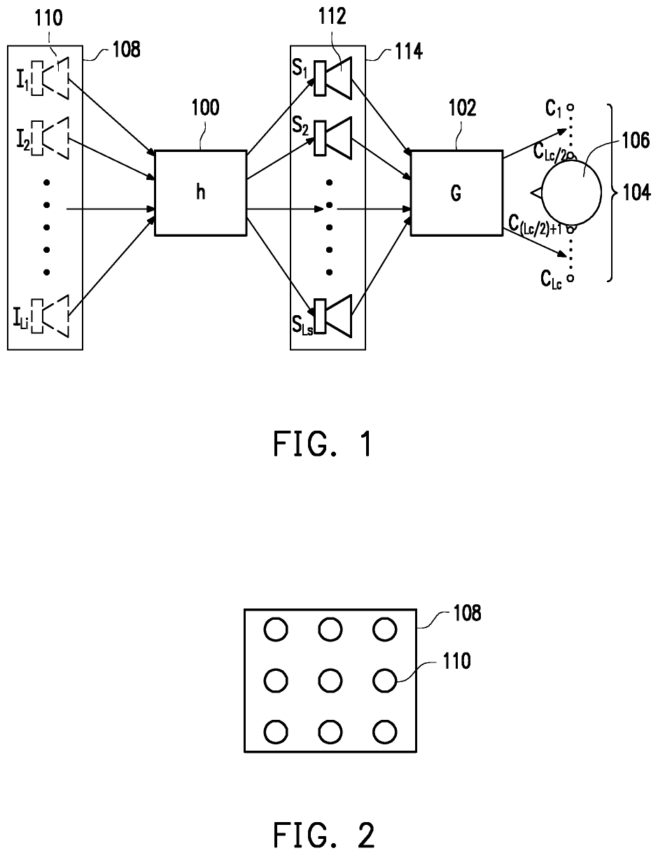

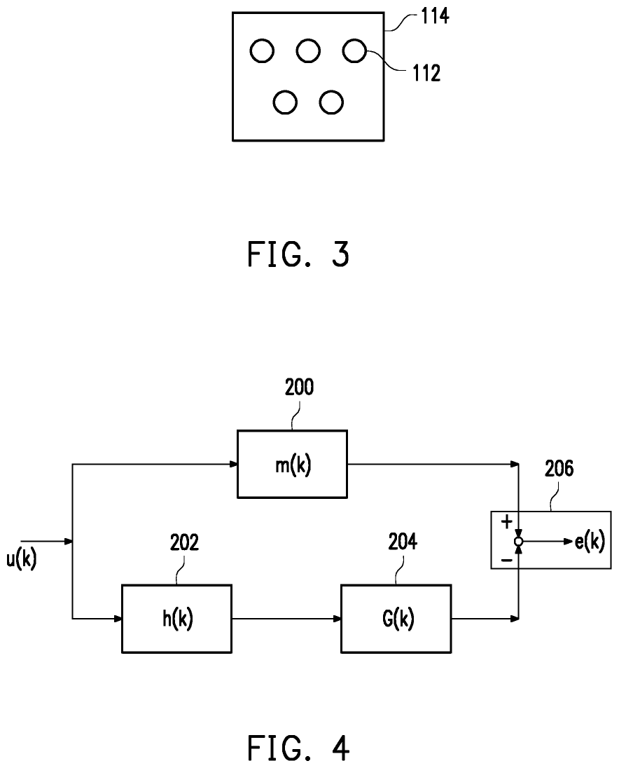

Quantities and positional distributions of virtual speakers and physical speakers may be different. FIG. 2 is a schematic diagram of a virtual speaker array according to an embodiment of the disclosure. Referring to FIG. 2, the virtual speaker array 108 is distributed in a planar direction as an example, which for example is a regular array, but is not limited to the regular array. FIG. 3 is a schematic diagram of a physical speaker array according to an embodiment of the disclosure. Referring to FIG. 3, the physical speaker array 114 is distributed in a planar direction as an example, in which the physical speakers 112 for example are also distributed into an array at predetermined positions. As such, the quantities and positional distributions of the virtual speakers 110 and the physical speakers 112 are different. However, driving the physical speakers 112 based on the model calculated by the filter matrix 100 can produce the effects of the virtual speakers 110.

Furthermore, the disclosure provides a speaker array using a multichannel inverse filtering principle under time-domain and is applicable for binaural sound effect production.

The binaural sound effect production system is as shown in FIG. 1. By playing using the physical speakers 112, a listener 106 is able to hear sound fields of different configurations set by the virtual speaker array 108. The system of the disclosure can be applied to crosstalk cancellation, expansion or displacement of two-channel sound source, channel 5.1 virtual surround sound system, etc.

From the principle perspective, the filter matrix 100 may be regarded as the h matrix. The sound response presented to the listener 106 at the control points C₁, C₂, . . . , C_{LC} can be represented by the G matrix 102. In addition, a target sound response to be obtained at each of the control points C₁, C₂, . . . , C_{LC} by the virtual speakers 110 of the virtual speaker array 108 is represented by the target matrix m. The target matrix m is the sound response to be presented to the listener 106 at the control points C₁, C₂, . . . , C_{LC}. Also, matrix calculation of G*h is the actual driving effect of the physical speaker array 114 by the filer matrix 100.

Under an ideal operation, which can be regarded as obtaining a condition equivalent to m=G*h, which is setting the target matrix m according to a selected operating model, and G*h matrix needs to be controllably adjusted to match with the target matrix m. The disclosure further provides effectively obtaining the output signals of the filter matrix 100 to drive the physical speaker array 114, so as to obtain the effects of the virtual speaker array 108.

FIG. 4 is a schematic diagram of matching mechanism of the physical speaker array and the virtual speaker array at control points according to an embodiment of the disclosure. Referring to FIG. 4, target matrix m is a model according to theoretical calculation, and may also be the result of measuring the values at the control points C₁, C₂, . . . , C_{LC} corresponding to each of the virtual speakers 110 in advance. G matrix is the effects at the control points C₁, C₂, . . . , C_{LC} corresponding to the action of the physical speakers 112 of the physical speaker array 114, and is expressed as a matrix. Thus, the values of the matrix elements can be obtained based on theoretical calculation or actual measurements under a standard reference status, and are unaffected by actual playing sound. The values of the matrix elements of the target matrix m are also obtained according to a model under a reference status, and are unaffected by actual playing sound. However, matrix elements of h matrix have to be controllably adjusted, so that the elements tend toward the ideal condition of m=G*h.

Referring to FIG. 1 for model matching under time domain, u(k) represents the output of the virtual speakers 110, so that the target sound response produced by each of the virtual speakers 110 at each of the control points C₁, C₂, . . . , C_{LC} configured in the form of a matrix can construct the target matrix 200 “m(k)”. In addition, under prediction of the same u(k), if there is an appropriate filter matrix 202 “h(k)”, driving signals may be produced to drive the physical speakers 112. Besides, the sound response of the physical speakers 112 to the control points under a reference condition is G matrix 204. As such, the difference value “e(k)” of sound responses on two paths is obtained by difference calculation of a variance block 206. By minimizing the difference value “e(k)”, the filter matrix 202 “h(k)” can be confirmed.

For actual adjustment of the filter, if G is regarded as in a full column rank or overdetermined condition, normally, there might be no solution. However, the difficulty may be solved by processing under the time domain and increasing the number of channels, so that G matrix becomes a square matrix or a full row rank.

A system of spreading the control points C₁, C₂, . . . along two sides of ears is regarded as a multichannel system. If a system is assumed to have L_{c} control points and Lₛ speakers, the impulse response between the j^{th} speaker and the i^{th} control point may be written as:

$${G}_{ij} = {[ \begin{matrix}{g}_{ij} ( 0 ) & 0 & 0 & 0 \\ {g}_{ij} ( 1 ) & {g}_{ij} ( 0 ) & 0 & ⋮ \\ ⋮ & {g}_{ij} ( 1 ) & ⋱ & 0 \\ {g}_{ij} ( {L}_{g} - 1 ) & ⋮ & ⋱ & {g}_{ij} ( 0 ) \\ 0 & {g}_{ij} ( {L}_{g} - 1 ) & ⋱ & {g}_{ij} ( 1 ) \\ ⋮ & ⋱ & ⋱ & ⋮ \\ 0 & ⋯ & 0 & {g}_{ij} ( {L}_{g} - 1 )\end{matrix} ]}_{L \times {L}_{h}}$$

The size of Gᵢⱼ matrix is L×Lₕ, L=L_{g}+Lₕ−1 can be determined based on the model, where L_{g} is the length of the impulse response between the speakers and the control points and is determined according to the sampling point. Lₕ represents the length of the filter obtained, for example, according to an estimate of the calculation. If the virtual sound sources, such as virtual speakers, that the system wants to present have Lᵢ virtual speakers, the m=Gh as mentioned above becomes the equation below:

$$[ \begin{matrix}{m}_{11} ( k ) \\ ⋮ \\ {m}_{{L}_{c} 1} ( k ) \\ {m}_{12} ( k ) \\ ⋮ \\ {m}_{{L}_{c} 2} ( k ) \\ ⋮ \\ {m}_{{1}_{{L}_{i}}} ( k ) \\ ⋮ \\ {m}_{{L}_{c} {L}_{i}} ( k )\end{matrix} ] = [ \begin{matrix}{G}_{11} ( k ) & ⋯ & {G}_{1 {L}_{s}} ( k ) & & & & & & & \\ ⋮ & ⋱ & ⋮ & & & & & & & \\ {G}_{{L}_{c} 1} ( k ) & ⋯ & {G}_{{L}_{c} {L}_{s}} ( k ) & & & & & & & \\ & & & {G}_{11} ( k ) & ⋯ & {G}_{1 {L}_{s}} ( k ) & & & & \\ & & & ⋮ & ⋱ & ⋮ & & & & \\ & & & {G}_{{L}_{c} 1} ( k ) & ⋯ & {G}_{{L}_{c} {L}_{s}} ( k ) & & & & \\ & & & & & & ⋱ & & & \\ & & & & & & & {G}_{11} ( k ) & ⋯ & {G}_{1 {L}_{s}} ( k ) \\ & & & & & & & ⋮ & ⋱ & ⋮ \\ & & & & & & & {G}_{{L}_{c} 1} ( k ) & ⋯ & {G}_{{L}_{c} {L}_{s}} ( k )\end{matrix} ] [ \begin{matrix}{h}_{11} ( k ) \\ ⋮ \\ {h}_{{L}_{s} 1} ( k ) \\ {h}_{12} ( k ) \\ ⋮ \\ {h}_{{L}_{s} 2} ( k ) \\ ⋮ \\ {h}_{{1}_{{L}_{i}}} ( k ) \\ ⋮ \\ {h}_{{L}_{s} {L}_{i}} ( k )\end{matrix} ]$$

wherein the size of the matrix G is 2L_{c} (L_{g}+Lₕ−1)×2LₛLₕ, and for the system to achieve the condition of underdetermined, an inequality equation thereof can be expressed as:

(L_{g}+Lₕ−1)L_{c}≤LₛLₕ.

After rearranging, the equation becomes:

$${L}_{h} \geq \frac{( {L}_{g} - 1 ) {L}_{c}}{{L}_{s} - {L}_{c}} .$$

Normally, the quantity of the speakers has to be limited to be equal to or more than the number of control points (Lₛ≥L_{c}). By appropriately adjusting lengths for the propagating matrix and the filter according to the inequality equation, the method of multichannel inverse filtering can be applied.

The matrix m is a target matrix set based on the ideal signals to be accomplished by the system. The system can be applied differently according to different target matrixes.

In consideration of left ear and right ear crosstalk cancellation in stereo channel, which for example can achieve an effect similar to earphones, and for example, is planned using the positional relationship of the ears, such that the value of matrix element mᵢₖ of the speaker (left speaker) and the ear (left ear) on the same side is valid, but the value of matrix element mᵢₖ of the speaker and the ear on the other side is set as zero. mᵢₖ is a one-dimensional matrix. In an embodiment of the disclosure, the target matrix corresponding to control points on the same side mᵢₖ is set as δ(n)=[1,0, . . . ,0]^{T}. The control points on the other side are set as zero to achieve the effect of minimizing audio on the other side.

With regard to expansion or displacement of a stereo-channel sound source, a channel 5.1 virtual surround system mᵢₖ is the impulse response from the source to the control points, and can be obtained using actual measurements or assumed mathematical model.

The gain value might be too big if inverse operation is used to obtain the filter directly, causing a difficult to implement the filters. Thus, in an embodiment, Tikhonov Regularization (TIKR) algorithm is used to derive the optimized filter matrix, and the solution of the h matrix can be obtained as below:

h=[G^{H}G+β²I]⁻¹G^{H}m,

where β is a regularization parameter, in which the smaller the value of β, the smaller the difference value as obtained. G^{H} matrix is a transposed-conjugate matrix of the G matrix, I is a unit matrix, “−1” represents inverse matrix, and m represents the target matrix in. However, considering the actual behavior of actual filters, the filters as obtained are likely to have multiple conflicting points under the range of the difference value. It is possible to adjust the value of β in the disclosure as appropriate, so as to find a filter matrix h to drive the physical speakers to have separation performance.

The disclosure uses the target matrix m to be obtained at the control points and the G matrix of the physical speakers at the control points to solve the filter matrix h, so as to drive the physical speakers to obtain the effects of the virtual speakers.

The disclosure increases the range of the best listening area using the control points, so that the system has robustness. Also, by changing the target matrix, the system can not only be applied to crosstalk cancellation (XTC), but also have other applications. The multichannel system that constructs the filter under time domain can set the filters that are relating to each other, and execute one-time optimization to all frequencies.

Besides, it shall be understood that in the overall operation of the system, equipment such as hardware control units and processing units to carry out needed calculations, processes, etc. are involved. For an ordinarily known method for example, corresponding driving electronic components and a computer can be used in assisting to accomplish the method, which is not limited to any specific method. Related detailed descriptions are omitted here.

Although the disclosure has been disclosed by the embodiments above, the disclosure is not limited to the embodiments. It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A binaural audio reproduction system, comprising:
a speaker array, comprising a plurality of speakers respectively disposed at a plurality of predetermined positions; and
a filter matrix, configured to output a plurality of driving signals to control the speakers, so as to produce a predetermined sound response to each of a plurality of control points within a control space,
wherein the driving signals of the filter matrix are determined according to a condition in reaching a match level between the sound response and a target sound response to be obtained at the control points from a virtual speaker array.

2. The binaural audio reproduction system according to claim 1, wherein the virtual speaker array comprises a plurality of predetermined virtual sound sources, the target sound response is an ideal response of the virtual sound sources respectively at each of the control points, and is a two-dimensional target matrix m set based on a matching model.

3. The binaural audio reproduction system according to claim 2, wherein the target matrix m is set based on a theoretical calculation.

4. The binaural audio reproduction system according to claim 2, wherein the target matrix m is set based on measurement values at the control points.

5. The binaural audio reproduction system according to claim 2, wherein each of the speakers has a two-dimensional G array constructed with reference to a response value to the control points, a one-dimensional h matrix is constructed corresponding to a plurality of matrix element values of the driving signals outputted by the filter matrix, wherein an arithmetic relationship between the h matrix and the G matrix is:
h=[G^{H}G+β²I]⁻¹G^{H}m,
wherein G^{H} matrix is a transposed-conjugate matrix of the G matrix, I is a unit matrix, parameter β is an adjustable parameter, “−1” represents an inverse matrix, and m represents the target matrix m.

6. The binaural audio reproduction system according to claim 5, wherein the condition in reaching a match level is minimizing a difference value between a product of the G matrix and the h matrix and the target matrix m, and sound quality effect is within an acceptable range.

7. The binaural audio reproduction system according to claim 6, wherein when a protruding point is generated between a plurality of filters of the filter matrix, the protruding point is eliminated by changing the parameter β, wherein the smaller the value of the parameter β, the smaller the difference value.

8. The binaural audio reproduction system according to claim 2, wherein the virtual speaker array comprises a plurality of virtual speakers, setting of the target matrix m comprises distinguishing the virtual speakers between left ear virtual speakers and right ear virtual speakers according to a left ear and a right ear of a user based on an earphone mechanism.

9. A binaural audio reproduction method, comprising:
providing a speaker array, comprising a plurality of speakers respectively disposed at a plurality of predetermined positions;
determining a virtual speaker array, comprising a plurality of virtual speakers respectively disposed at a plurality of predetermined positions; and
providing a filter matrix, outputting a plurality of driving signals to control the speakers, so as to produce a predetermined sound response to each of control points within a control space,
wherein the driving signals of the filter matrix are determined according to a condition in reaching a match level between the sound response and a target sound response to be obtained at the control points from the virtual speaker array.

10. The binaural audio reproduction method according to claim 9, wherein the virtual speaker array comprises a plurality of predetermined virtual sound sources, the target sound response is an ideal response of the virtual sound sources respectively at each of the control points, and is a two-dimensional target matrix m set based on a matching model.

11. The binaural audio reproduction method according to claim 9, wherein the target matrix m is set based on a theoretical calculation.

12. The binaural audio reproduction method according to claim 9, wherein the target matrix m is set based on measurement values at the control points.

13. The binaural audio reproduction method according to claim 9, wherein each of the speakers has a two-dimensional G array constructed with reference to a response value to the control points, a one-dimensional h matrix is constructed corresponding to a plurality of matrix element values of the driving signals outputted by the filter matrix, wherein an arithmetic relationship between the h matrix and the G matrix is:
h=[G^{H}G+β²I]⁻¹G^{H}m,
wherein G^{H} matrix is a transposed-conjugate matrix of the G matrix, I is a unit matrix, parameter β is an adjustable parameter, “−1” represents an inverse matrix, and m represents the target matrix m.

14. The binaural audio reproduction method according to claim 13, wherein the condition in reaching a match level is a difference value between a product of the G matrix and the h matrix and the target matrix m within a predetermined range.

15. The binaural audio reproduction method according to claim 14, wherein when a protruding point is generated between a plurality of filters of the filter matrix, the protruding point is eliminated by changing the parameter β, wherein the smaller the value of the parameter β, the smaller the difference value.

16. The binaural audio reproduction method according to claim 9, wherein the virtual speaker array comprises a plurality of virtual speakers, setting of the target matrix m comprises distinguishing the virtual speakers between left ear virtual speakers and right ear virtual speakers according to a left ear and a right ear of a user based on an earphone mechanism.
